(19) United States
(12) Patent Application Publication
(10) Pub. No.: US 2026/0296270 A1
(43) Pub. Date: Oct. 1, 2026

(54) ELECTRIFIED VEHICLE

(71) Applicant: SUBARU CORPORATION, Tokyo (JP)

(72) Inventors: Ryota Iwahara, Tokyo (JP); Makoto Nishida, Tokyo (JP)

(73) Assignee: SUBARU CORPORATION, Tokyo (JP)

(21) Appl. No.: 19/567,553

(22) Filed: Mar. 16, 2026

(30) Foreign Application Priority Data
Mar. 26, 2025 (JP) 2025-052131

(51) Int. Cl. B60L 58/27; B60L 53/16; B60L 53/62; B60L 58/12

(52) U.S. Cl. CPC B60L 58/27; B60L 53/16; B60L 53/62; B60L 58/12; B60L 2210/12; B60L 2240/545

(57) ABSTRACT

The control system is configured to execute warm-up control that operates the first heat generator and the second heat generator when a charging connector extending from an external power source is coupled to a charging inlet and the temperature of an energy storage pack falls below a threshold. The control system is configured to, upon executing the warm-up control, calculate an acceptable power of the energy storage pack, control the first heat generator based on a first target power consumption that is equal to or lower than the acceptable power, and control the second heat generator based on a second target power consumption that is equal to or lower than the acceptable power.

### CROSS-REFERENCE TO RELATED APPLICATIONS

The present application claims priority from Japanese Patent Application No. 2025-052131 filed on Mar. 26, 2025, the entire contents of which are hereby incorporated by reference.

### BACKGROUND

The present disclosure relates to electrified vehicles.

Electrified vehicles such as battery electric vehicles and plug-in hybrid electric vehicles include a battery pack (i.e., an energy storage pack) that is made up of lithium-ion battery cells and other components (see Japanese Unexamined Patent Application Publication (JP-A) Nos. 2020-162296, 2013-233010, and 2019-134589). The energy storage pack can be charged from an external power source either by using an external charger installed outside the vehicle or by using an on-board charger mounted in the vehicle.

### SUMMARY

An electrified vehicle according to one embodiment of the present disclosure includes a charging inlet, a first current path, a second current path, a third current path, and an energy storage pack. The charging inlet is provided on a vehicle body. The first current path is configured to be coupled to the charging inlet. The second current path is configured to be coupled to the first current path. The third current path is configured to be coupled to the first current path. The energy storage pack is configured to be coupled to the second current path. The electrified vehicle includes a first heat generator. The first heat generator is configured to be coupled to the third current path and to supply heat to the energy storage pack. The electrified vehicle includes a second heat generator. The second heat generator is configured to be coupled to the third current path and to supply heat to the energy storage pack. The electrified vehicle includes a control system including a processor and a memory that are communicatively coupled to each other. The control system is configured to execute warm-up control. The warm-up control operates the first heat generator and the second heat generator when a charging connector extending from an external power source is coupled to the charging inlet and the temperature of the energy storage pack falls below a threshold. The control system is configured to calculate an acceptable power of the energy storage pack upon executing the warm-up control. The control system is configured to control the first heat generator based on a first target power consumption that is equal to or lower than the acceptable power. The control system is configured to control the second heat generator based on a second target power consumption that is equal to or lower than the acceptable power.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an electrified vehicle according to an embodiment of the present disclosure;

FIG. 2 is a diagram illustrating an external charging system and a temperature management system;

FIG. 3 is a diagram illustrating the temperature management system operating in a battery cooling mode;

FIG. 4 is a diagram illustrating the temperature management system operating in a battery heating mode;

FIG. 5 is a diagram illustrating an example of a basic structure of an electronic control unit;

FIG. 6 is a flowchart illustrating an example of a warm-up control execution procedure;

FIG. 7 is a flowchart illustrating an example of the warm-up control execution procedure;

FIG. 8 is a flowchart illustrating an example of the warm-up control execution procedure;

FIG. 9A is a graph illustrating an example of the relationship between battery temperature and acceptable power;

FIG. 9B is a graph illustrating an example of the relationship between SOC and acceptable power;

FIG. 10 is a diagram illustrating an example of the coolant circulation state and the power supply state during warm-up control;

FIG. 11 is a diagram illustrating an example of the coolant circulation state and the power supply state during warm-up control;

FIG. 12A is a diagram illustrating a breakdown of the consumption of the charger power illustrated in FIG. 10;

FIG. 12B is a diagram illustrating a breakdown of the consumption of the charger power illustrated in FIG. 11;

FIG. 13A is a diagram illustrating a breakdown of the consumption of the charger power during warm-up control according to a modification;

FIG. 13B is a diagram illustrating a breakdown of the consumption of the charger power during warm-up control according to the modification; and

FIG. 14 is a diagram illustrating an electrified vehicle according to another modification.

### DETAILED DESCRIPTION

Since the internal resistance of the energy storage pack increases as its temperature decreases, warming the energy storage pack is desirable for efficient charging in low-temperature environments. Accordingly, it is desirable to quickly warm the energy storage pack.

Embodiments of the disclosure will be described in detail below with reference to the drawings. In the following description, the same or substantially the same components and elements are denoted by the same reference signs and repeated description will be omitted. Note that the following description is directed to an illustrative example of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiment which are not recited in a most-generic independent claim of the disclosure are optional and may be provided on an as-needed basis. The drawings are schematic and are not intended to be drawn to scale.

### Vehicle Overview

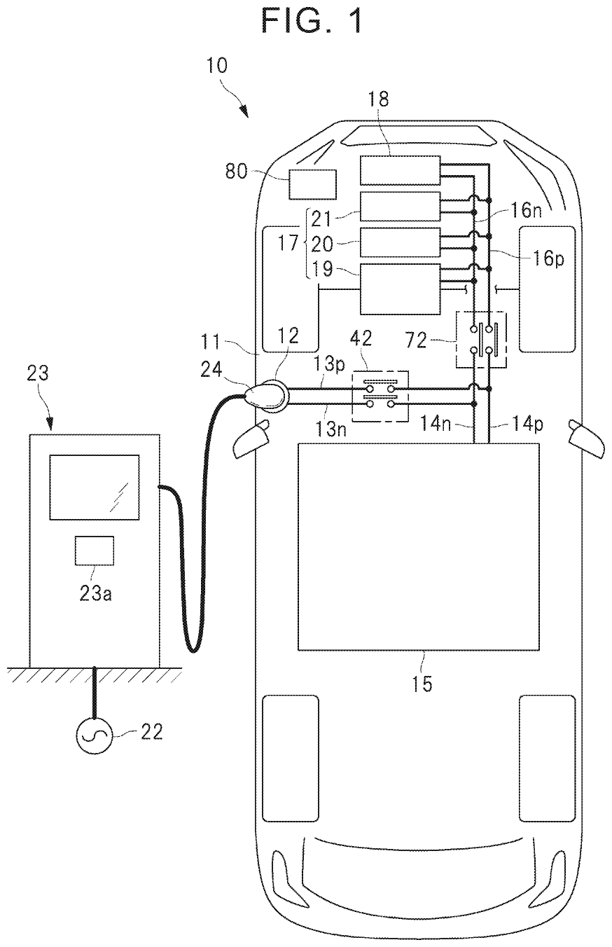

FIG. 1 illustrates an electrified vehicle 10 according to an embodiment. As illustrated in FIG. 1, the electrified vehicle 10 includes a charging inlet 12 provided on a vehicle body 11, and power lines 13p, 13n coupled to the charging inlet 12. The electrified vehicle 10 further includes power lines 14p, 14n coupled respectively to the power lines 13p, 13n, and a battery pack (energy storage pack) 15 coupled to the power lines 14p, 14n. The electrified vehicle 10 further includes power lines 16p, 16n coupled respectively to the power lines 13p, 13n, a unit group 17 coupled to the power lines 16p, 16n, and a step-down converter 18 coupled to the power lines 16p, 16n. The unit group 17 includes an electric axle 19, an electric compressor 20, and a high-voltage heater 21.

The battery pack 15 mounted on the vehicle body 11 supports external charging, that is, it can be charged using an external power source 22 that is a commercial power supply. A charging connector 24 extending from an external charger (charger) 23 is coupled to the charging inlet 12 by an operator performing external charging. When the charging connector 24 is coupled to the charging inlet 12, a control signal is transmitted from a control system 80 (described later) to the external charger 23. The external charger 23 converts the alternating current power from the external power source 22 into direct current power and outputs the direct current power. In this way, the external charger 23 supplies direct current power to the battery pack 15. The battery pack 15 is charged toward a target state of charge (SOC).

### Battery Pack

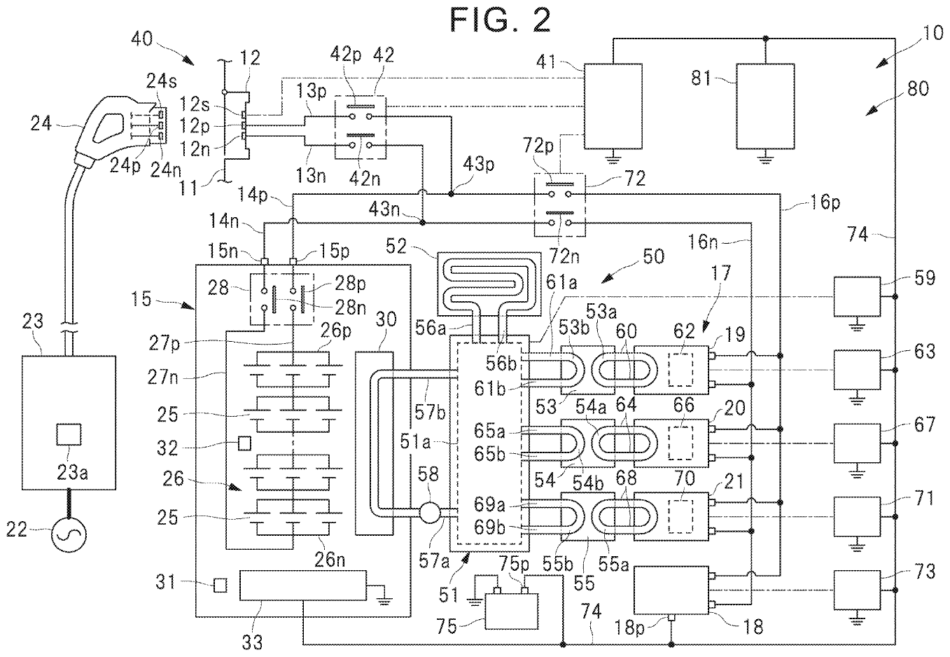

FIG. 2 illustrates an external charging system 40 and a temperature management system 50. As illustrated in FIG. 2, the battery pack 15 includes a battery module 26 made up of a plurality of battery cells 25. A positive electrode 26p of the battery module 26 is coupled to a positive terminal 15p via a positive line 27p. A negative electrode 26n of the battery module 26 is coupled to a negative terminal 15n via a negative line 27n. The battery pack 15 further includes a battery relay 28p provided on the positive line 27p and a battery relay 28n provided on the negative line 27n. The battery pack 15 thus has a relay unit 28 made up of the battery relays 28p, 28n. The battery pack 15 further includes a water jacket 30 through which coolant flows. The battery pack 15 further includes a battery sensor 31 that detects charge/discharge current and terminal voltage, and a temperature sensor 32 that detects the temperature of the battery module 26, i.e., the temperature of the battery pack 15.

The battery pack 15 includes a battery controller 33 that is an electronic control unit. The battery controller 33 serves to monitor charging and discharging of the battery pack 15 and to control the relay unit 28. The battery controller 33 also serves to calculate the state of charge (SOC) of the battery pack 15 based on the charge/discharge current and terminal voltage of the battery pack 15. The SOC of the battery pack 15 is a value indicating the remaining charge in the battery pack 15, expressed as the ratio of the remaining charge to the full charge capacity of the battery pack 15. For example, when the battery pack 15 is charged to its upper capacity limit, the SOC is calculated as 100%. For example, when the battery pack 15 is discharged to its lower capacity limit, the SOC is calculated as 0%.

### External Charging System

The electrified vehicle 10 includes the external charging system 40 made up of the charging inlet 12, a charging controller 41, and the like. The charging inlet 12 includes a positive terminal 12p coupled to a power line (first current path) 13p, a negative terminal 12n coupled to a power line 13n, and a communication terminal 12s coupled to the charging controller 41. An inlet relay (inlet-side switch) 42p is provided on the power line 13p. An inlet relay 42 n is provided on the power line 13n. In this manner, a relay unit 42 made up of the inlet relays 42p, 42n is provided on the power lines 13p, 13n.

The electrified vehicle 10 further includes a power line (second current path) 14p coupled to the power line 13p via a connection point 43 p, and a power line 14n coupled to the power line 13n via a connection point 43 n. The power line 14p is coupled to the positive terminal 15p of the battery pack 15, and the power line 14n is coupled to the negative terminal 15n of the battery pack 15. The charging inlet 12 and the battery pack 15 are thus coupled to each other via the power lines 13p, 13n, 14p, 14n and the relay unit 42.

The charging controller 41 that is an electronic control unit is communicatively coupled to the communication terminal 12s of the charging inlet 12. In other words, when the charging connector 24 is coupled to the charging inlet 12, the external charger 23 and the charging controller 41 are communicatively coupled to each other. To execute external charging, the charging controller 41 transmits control signals such as a target charging voltage and a target charging current to a controller 23a of the external charger 23. The charging controller 41 also switches the relay unit 42 to a conducting (ON) state and, via the battery controller 33, switches the relay unit 28 to a conducting (ON) state. As a result, the external charger 23 supplies direct current power to the battery pack 15 and charges the battery pack 15.

The charging connector 24 configured to be coupled to the charging inlet 12 includes a positive terminal 24p configured to mate with the positive terminal 12p, a negative terminal 24n configured to mate with the negative terminal 12n, and a communication terminal 24s configured to mate with the communication terminal 12s.

### Temperature Management System

The electrified vehicle 10 includes the temperature management system 50 that regulates the temperature of the battery pack 15. The temperature management system 50 includes a switching valve 51, a radiator 52, and a plurality of heat exchangers 53, 54, 55. The switching valve 51 is coupled to the radiator 52 via pipes 56a, 56b. The switching valve 51 is coupled to the water jacket 30 of the battery pack 15 via pipes 57a, 57b. The temperature management system 50 further includes an electric water pump 58 provided on the pipe 57a. The temperature management system 50 further includes a temperature controller 59 that controls the switching valve 51 and the water pump 58.

The heat exchanger 53 includes two heat exchange flow paths 53a, 53b. The heat exchange flow path 53a is coupled to the electric axle 19 via a pipe 60. The heat exchange flow path 53b is coupled to the switching valve 51 via pipes 61a, 61b. The electric axle 19 that is a heat generator includes a stator coil 62 that generates heat when current is supplied. When thermal energy is supplied from the electric axle 19 to the heat exchanger 53, oil inside the electric axle 19 that has been heated by the stator coil 62 is delivered from the electric axle 19 to the heat exchange flow path 53a of the heat exchanger 53. The heat generation state of the electric axle 19 is controlled by an axle controller 63 that is an electronic control unit.

The heat exchanger 54 includes two heat exchange flow paths 54a, 54b. The heat exchange flow path 54a is coupled to the electric compressor 20 via a pipe 64. The heat exchange flow path 54b is coupled to the switching valve 51 via pipes 65a, 65b. The electric compressor 20 that is a heat generator includes a condenser 66 through which high-temperature refrigerant gas is guided. When thermal energy is supplied from the electric compressor 20 to the heat exchanger 54, circulating fluid inside the electric compressor 20 that has been heated by the condenser 66 is delivered from the electric compressor 20 to the heat exchange flow path 54a of the heat exchanger 54. The heat generation state of the electric compressor 20 is controlled by a compressor controller 67 that is an electronic control unit.

The heat exchanger 55 includes two heat exchange flow paths 55a, 55b. The heat exchange flow path 55a is coupled to the high-voltage heater 21 via a pipe 68. The heat exchange flow path 55b is coupled to the switching valve 51 via pipes 69a, 69b. The high-voltage heater 21 that is a heat generator includes a heat generating element 70 that generates heat when current is supplied. When thermal energy is supplied from the high-voltage heater 21 to the heat exchanger 55, circulating fluid inside the high-voltage heater 21 that has been heated by the heat generating element 70 is delivered from the high-voltage heater 21 to the heat exchange flow path 55a of the heat exchanger 55. The heat generation state of the high-voltage heater 21 is controlled by a heater controller 71 that is an electronic control unit.

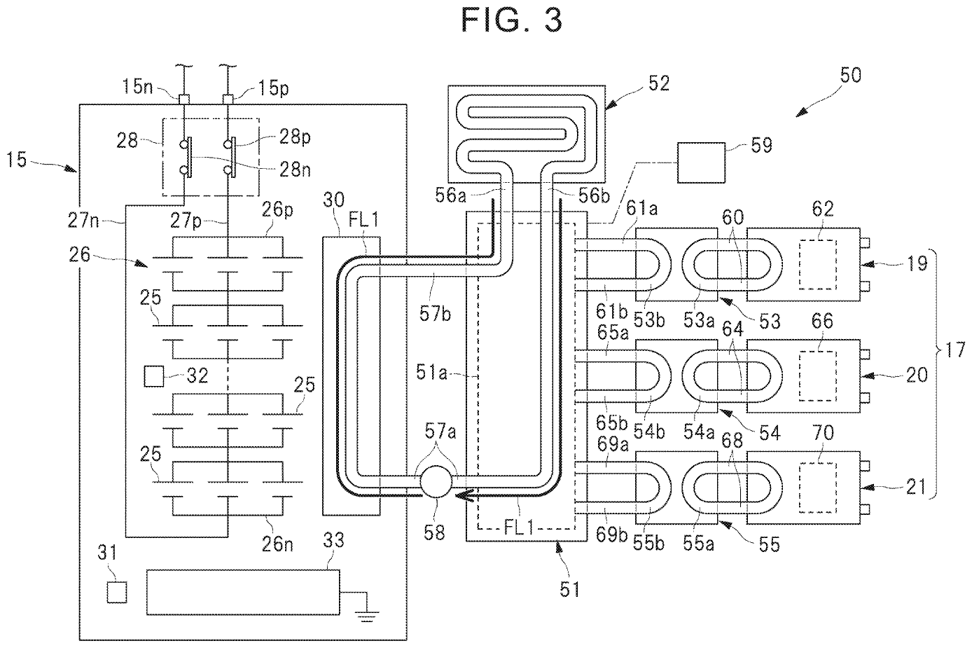

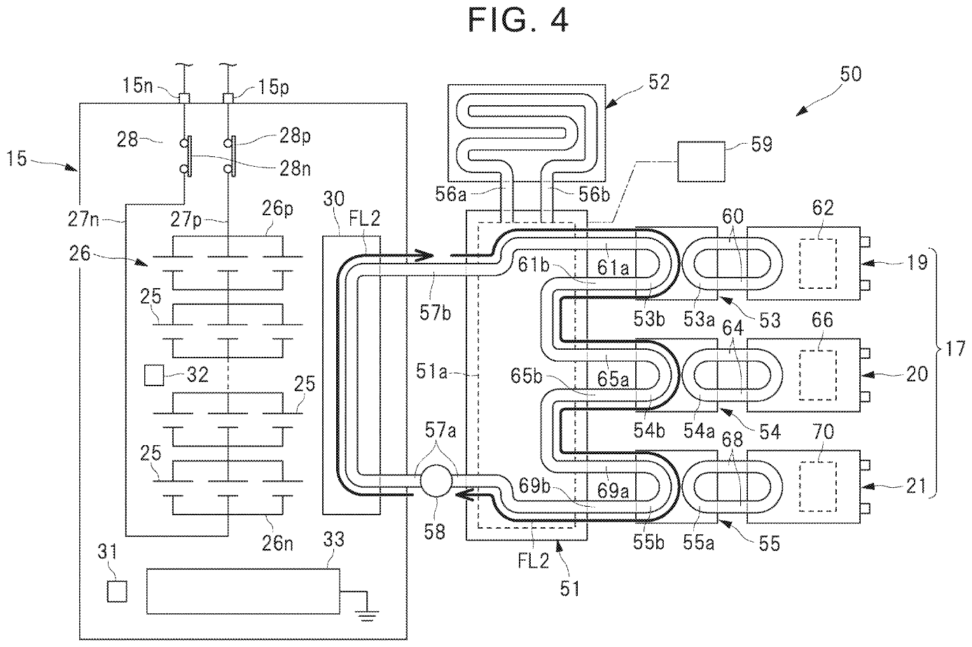

A valve element 51a of the switching valve 51 is operable between a cooling position in which the water jacket 30 is coupled to the radiator 52, and a heating position in which the water jacket 30 is coupled to the heat exchangers 53 to 55. As illustrated in FIG. 3 described later, when the valve element 51a of the switching valve 51 is set to the cooling position, the pipe 57b is coupled to the pipe 56a, and the pipe 56b is coupled to the pipe 57a. As illustrated in FIG. 4 described later, when the valve element 51a of the switching valve 51 is set to the heating position, the pipe 57b is coupled to the pipe 61a, the pipe 61b is coupled to the pipe 65a, the pipe 65b is coupled to the pipe 69a, and the pipe 69b is coupled to the pipe 57a.

### Battery Cooling Mode and Battery Heating Mode

The temperature management system 50 includes the temperature controller 59 that is an electronic control unit. The temperature controller 59 outputs control signals to the switching valve 51, the water pump 58, and the like, activating the temperature management system 50 to control the battery pack 15 within a predetermined temperature range. That is, when the temperature of the battery pack 15 exceeds a predetermined upper threshold, the temperature controller 59 executes a battery cooling mode to cool the battery pack 15. On the other hand, when the temperature of the battery pack 15 falls below a predetermined lower threshold, the temperature controller 59 executes a battery heating mode to warm the battery pack 15.

FIG. 3 illustrates the temperature management system 50 operating in the battery cooling mode. As illustrated in FIG. 3, when the temperature controller 59 executes the battery cooling mode, it sets the valve element 51a of the switching valve 51 to the cooling position and drives the water pump 58. This allows coolant to circulate between the water jacket 30 and the radiator 52 as indicated by arrows FL1. In other words, the coolant cooled by passing through the radiator 52 can be supplied to the water jacket 30, thereby cooling the battery pack 15.

FIG. 4 illustrates the temperature management system 50 operating in the battery heating mode. As illustrated in FIG. 4, when the temperature controller 59 executes the battery heating mode, it sets the valve element 51a of the switching valve 51 to the heating position and drives the water pump 58. When the temperature controller 59 executes the battery heating mode, it also controls some or all of the electric axle 19, the electric compressor 20, and the high-voltage heater 21 into a heat generating state via the respective controllers 63, 67, 71.

As indicated by arrows FL2, the coolant discharged from the water jacket 30 is warmed while passing through the heat exchangers 53 to 55 and is then returned to the water jacket 30. In other words, the electric axle 19, the electric compressor 20, and the high-voltage heater 21 warm the battery pack 15 by supplying thermal energy to the battery pack 15. As described above, in the battery heating mode, the coolant flowing through the water jacket 30 serves as a heat transfer medium for warming the battery pack 15.

### Power Supply Circuit

As illustrated in FIG. 2, the electrified vehicle 10 includes power lines 16p, 16n that supply electric power to the electric axle 19, the electric compressor 20, the high-voltage heater 21, and the step-down converter 18. That is, the electrified vehicle 10 includes the power line (third current path) 16p coupled to the power line 13p via the connection point 43p, and the power line 16n coupled to the power line 13n via the connection point 43n. A main relay (unit-side switch) 72p is provided on the power line 16p. A main relay 72n is provided on the power line 16n. In this manner, a relay unit 72 made up of the main relays 72p, 72n is provided on the power lines 16p, 16n.

The step-down converter 18 serves to convert high-voltage direct current power into low-voltage (for example, 12 V) direct current power. The operating state of the step-down converter 18 is controlled by a converter controller 73 that is an electronic control unit. An output terminal 18p of the step-down converter 18 is coupled to a positive terminal 75p of a low-voltage battery 75 via a power line 74, and is also coupled to each of the controllers 33, 41, 59, 63, 67, 71, 73, 81 via the power line 74. In other words, each of the controllers 33, 41, 59, 63, 67, 71, 73, 81 is supplied with electric power from the step-down converter 18 as well as from the low-voltage battery 75.

### Control System

As illustrated in FIG. 2, the electrified vehicle 10 includes the control system 80 made up of a plurality of electronic control units. The electronic control units that make up the control system 80 include the battery controller 33, the charging controller 41, the temperature controller 59, the axle controller 63, the compressor controller 67, the heater controller 71, and the converter controller 73, which are described above. The electronic control units that make up the control system 80 also include the vehicle controller 81 that outputs control signals to these controllers.

These controllers 33, 41, 59, 63, 67, 71, 73, 81 are communicatively coupled to each other via an in-vehicle network (not illustrated). The vehicle controller 81 sets operation targets for the external charging system 40 and the temperature management system 50, based on input information from the controllers 33, 41, 59, 63, 67, 71, 73 and various sensors. The vehicle controller 81 also generates control signals in accordance with the operation targets for the external charging system 40 and the temperature management system 50, and outputs the control signals to the controllers 33, 41, 59, 63, 67, 71, 73.

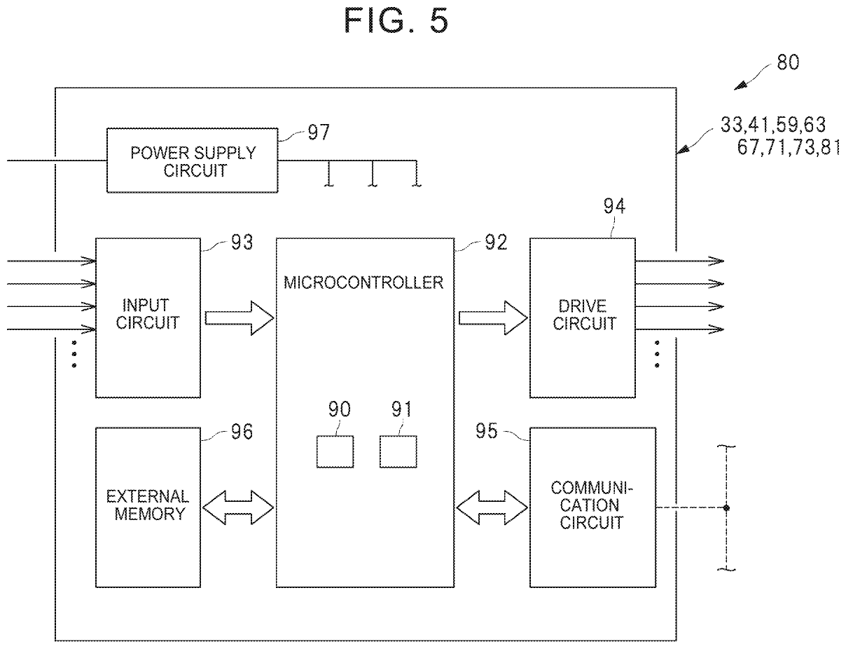

FIG. 5 illustrates an example of the basic structure of the controllers 33, 41, 59, 63, 67, 71, 73, 81. As illustrated in FIG. 5, each of the controllers 33, 41, 59, 63, 67, 71, 73, 81 includes a microcontroller 92. The microcontroller 92 incorporates a processor 90, a main memory (memory) 91, and the like. A predetermined program is stored in the main memory 91, and the processor 90 executes the program. The processor 90 and the main memory 91 are communicatively coupled to each other. The microcontroller 92 may incorporate a plurality of the processors 90. The microcontroller 92 may incorporate a plurality of the main memories 91.

Each of the controllers 33, 41, 59, 63, 67, 71, 73, 81 further includes an input circuit 93, a drive circuit 94, a communication circuit 95, an external memory 96, and a power supply circuit 97. The input circuit 93 converts signals received from various sensors into signals that can be input to the microcontroller 92. The drive circuit 94 generates drive signals for devices such as the switching valve 51 and the electric axle 19, based on signals output from the microcontroller 92.

The communication circuit 95 converts signals output from the microcontroller 92 into communication signals for other electronic control units and the like. The communication circuit 95 also converts communication signals received from other electronic control units and the like into signals that can be input to the microcontroller 92. The power supply circuit 97 supplies a power supply voltage to the microcontroller 92, the input circuit 93, the drive circuit 94, the communication circuit 95, the external memory 96, and the like. The external memory 96 made up of nonvolatile memory or the like stores programs and various types of data.

Warm-up control for heating the battery pack 15 will now be described. The internal resistance of the battery pack 15 increases as its temperature decreases. Warming the battery pack 15 before external charging is therefore desirable for efficient charging of the battery pack 15 in low-temperature environments. Accordingly, when the charging connector 24 is coupled to the charging inlet 12 in a low-temperature environment, the electrified vehicle 10 of the present disclosure warms the battery pack 15 before external charging by executing warm-up control described below.

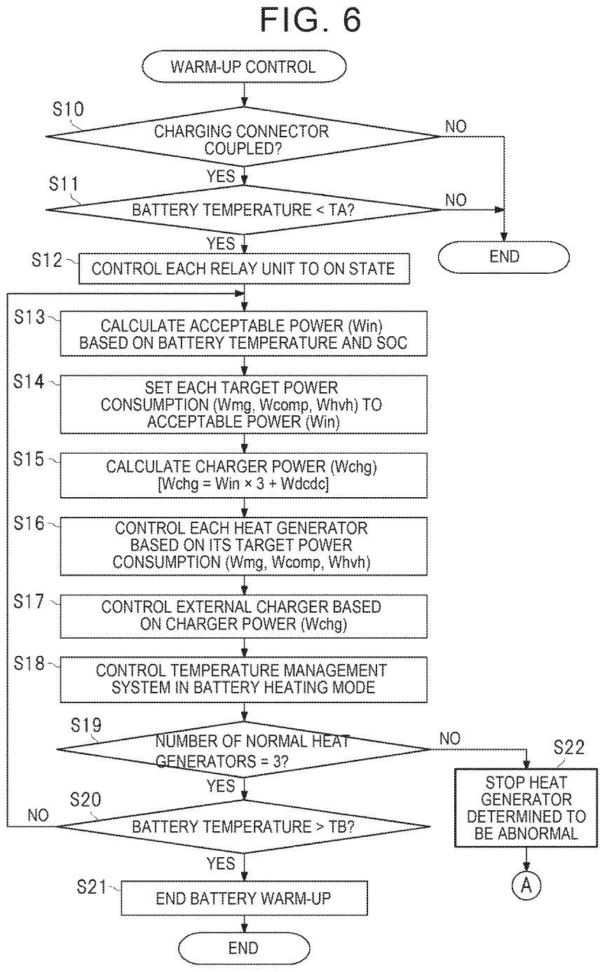

FIGS. 6, 7, and 8 are flowcharts illustrating an example of a warm-up control execution procedure. The flowcharts of FIGS. 6, 7, and 8 are connected together at locations labeled A and B. Each step illustrated in the flowcharts of FIGS. 6, 7, and 8 is executed by the processor 90 that constitutes the control system 80. The warm-up control illustrated in FIGS. 6, 7, and 8 is executed by the control system 80 at predetermined time intervals. In the following description, the electric axle 19, the electric compressor 20, and the high-voltage heater 21 are sometimes referred to as “heat generators 19, 20, 21.”

As illustrated in FIG. 6, the control system 80 first determines in step S10 whether the charging connector 24 is coupled to the charging inlet 12. When the control system 80 determines in step S10 that the charging connector 24 is coupled to the charging inlet 12, the process proceeds to step S11, where the control system 80 determines whether the temperature of the battery pack 15 (hereinafter referred to as “battery temperature”) is below a threshold TA. When the control system 80 determines in step S11 that the battery temperature is below the threshold TA, the process proceeds to step S12, where the control system 80 controls the relay units 28, 42, 72 to a conducting (ON) state. Since the condition in which the battery temperature is below the threshold TA in step S11 corresponds to a situation where external charging is initiated under low-temperature conditions, the process proceeds to step S12, where various processes for performing battery warm-up are started.

After the relay units 28, 42, 72 are controlled to the ON state in step S12, the process proceeds to step S13, where the control system 80 calculates the acceptable power Win of the battery pack 15 based on the battery temperature and the SOC. The acceptable power Win calculated in step S13 is the power at which the battery pack 15 can be charged while maintaining the normal state of the battery pack 15.

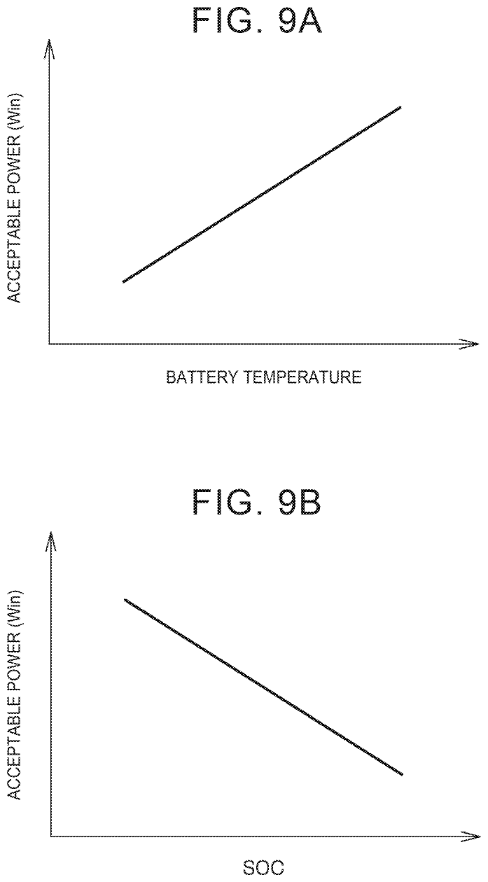

FIG. 9A is a graph illustrating an example of the relationship between battery temperature and acceptable power Win, and FIG. 9B is a graph illustrating an example of the relationship between SOC and acceptable power Win. As illustrated in FIG. 9A, the control system 80 calculates a larger acceptable power Win as the battery temperature increases. In other words, the control system 80 calculates a smaller acceptable power Win as the battery temperature decreases. As illustrated in FIG. 9B, the control system 80 calculates a smaller acceptable power Win as the SOC increases. In other words, the control system 80 calculates a larger acceptable power Win as the SOC decreases.

After the control system 80 calculates the acceptable power Win in step S13, the process proceeds to step S14. In step S14, the control system 80 sets the target power consumption (first target power consumption) Wmg of the electric axle (first heat generator) 19 to the acceptable power Win. In step S14, the control system 80 also sets the target power consumption (second target power consumption) Wcomp of the electric compressor (second heat generator) 20 to the acceptable power Win. Similarly, in step S14, the control system 80 sets the target power consumption Whvh of the high-voltage heater 21 to the acceptable power Win.

The process then proceeds to step S15, where the control system 80 calculates the charger power (requested output power) Wchg requested of the external charger 23, based on the following equation (1). In equation (1), the output power Wdcdc represents the output power of the step-down converter 18 detected by the converter controller 73, that is, the power consumed by the control system 80 during execution of the battery warm-up.

$$Wchg = Win \times 3 + Wdcdc \qquad ( 1 )$$

The process then proceeds to step S16, where the control system 80 controls the electric axle 19 based on the target power consumption Wmg, controls the electric compressor 20 based on the target power consumption Wcomp, and controls the high-voltage heater 21 based on the target power consumption Whvh. That is, the control system 80 controls the heat generation states of the heat generators 19 to 21 such that the respective power consumptions of the heat generators 19, 20, 21 reach the acceptable power Win.

The process then proceeds to step S17, where the control system 80 instructs the external charger 23 to output the charger power Wchg. Thereafter, in step S18, the control system 80 controls the temperature management system 50 in the battery heating mode. That is, the control system 80 controls the valve element 51a of the switching valve 51 to the heating position and controls the water pump 58 to operate.

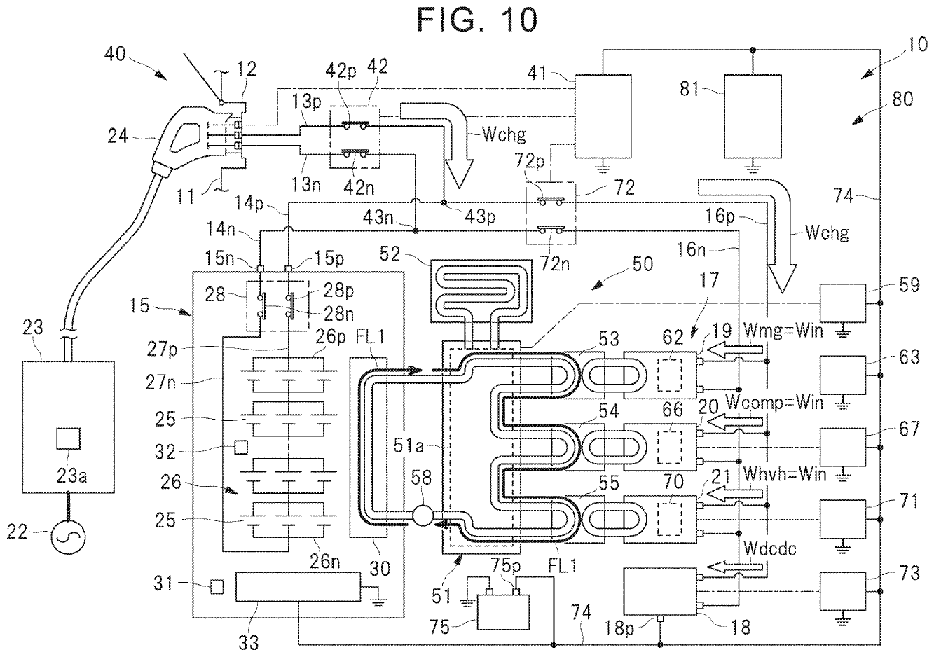

FIG. 10 illustrates an example of the coolant circulation state and the power supply state during warm-up control. As illustrated in FIG. 10, by controlling the temperature management system 50 in the battery heating mode, coolant can be circulated between the water jacket 30 and the heat exchangers 53 to 55, as indicated by arrows FL1. Accordingly, heat energy can be supplied from the heat generators 19 to 21 to the battery pack 15, thereby warming the battery pack 15.

As indicated by the white arrows in FIG. 10, the charger power Wchg supplied from the external charger 23 to the charging inlet 12 is delivered through the power line 13p and the power line 16p to each of the electric axle 19, the electric compressor 20, the high-voltage heater 21, and the step-down converter 18. At this time, the power consumption Wmg of the electric axle 19, the power consumption Wcomp of the electric compressor 20, and the power consumption Whvh of the high-voltage heater 21 are each controlled so as to match the acceptable power Win of the battery pack 15. In this manner, the heat generators 19 to 21 and the control system 80 operate using the charger power Wchg supplied from the external charger 23.

As illustrated in FIG. 6, when the control system 80 controls the temperature management system 50 in the battery heating mode in step S18, the process proceeds to step S19, where the control system 80 determines whether all of the heat generators 19 to 21 are normal. That is, the axle controller 63 determines whether the electric axle 19 is normal. The compressor controller 67 determines whether the electric compressor 20 is normal. The heater controller 71 determines whether the high-voltage heater 21 is normal. The vehicle controller 81 constituting the control system 80 then determines whether all of the heat generators 19 to 21 are operating normally, based on information transmitted from the controllers 63, 67, 71.

When the control system 80 determines in step S19 that the number of normal heat generators is “3,” that is, when it determines that all the heat generators 19 to 21 remain normal, the process proceeds to step S20. In step S20, the control system 80 determines whether the battery temperature exceeds a threshold TB that is higher than the threshold TA. When the control system 80 determines in step S20 that the battery temperature exceeds the threshold TB, that is, when it determines that the battery pack 15 has been sufficiently warmed, the process proceeds to step S21 and ends the battery warm-up. When the control system 80 determines in step S20 that the battery temperature is lower than or equal to the threshold TB, the process returns to step S13, where the control system 80 continues the battery warm-up while updating the acceptable power Win and the charger power Wchg.

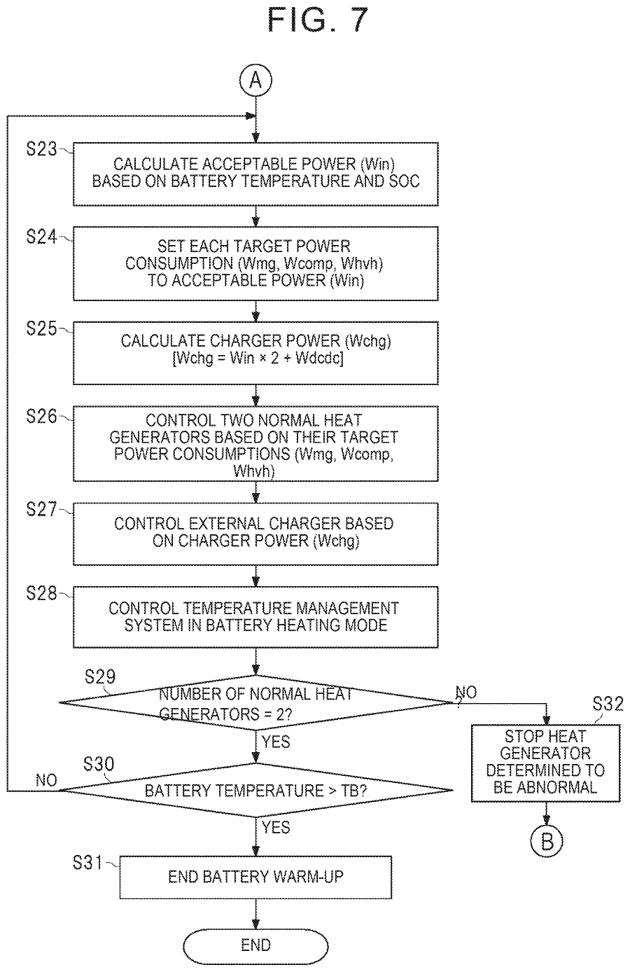

When the control system 80 determines in step S19 that the number of normal heat generators is not “3,” the process proceeds to step S22. That is, when the control system 80 determines that any of the three heat generators 19 to 21 is abnormal, the process proceeds to step S22. In step S22, the control system 80 stops the heat generators determined to be abnormal. Thereafter, as illustrated in FIG. 7, the process proceeds to step S23, where the control system 80 calculates the acceptable power Win of the battery pack 15 based on the battery temperature and the SOC.

After the control system 80 calculates the acceptable power Win in step S23, the process proceeds to step S24. In step S24, the control system 80 sets the target power consumption Wmg of the electric axle 19 to the acceptable power Win. In step S24, the control system 80 also sets the target power consumption Wcomp of the electric compressor 20 to the acceptable power Win. In step S24, the control system 80 also sets the target power consumption Whvh of the high-voltage heater 21 to the acceptable power Win. The process then proceeds to step S25, where the control system 80 calculates the charger power Wchg requested of the external charger 23, based on the following equation (2).

$$Wchg = Win \times 2 + Wdcdc \qquad ( 2 )$$

The process then proceeds to step S26, where the control system 80 controls the two normal heat generators based on their corresponding target power consumptions among Wmg, Wcomp, Whvh. For example, when two of the heat generators 19 to 21, namely the electric axle 19 and the electric compressor 20, are normal, the control system 80 controls the electric axle 19 based on the target power consumption Wmg, and controls the electric compressor 20 based on the target power consumption Wcomp. In other words, the control system 80 controls the heat generation states of the heat generators 19, 20 such that the respective power consumptions of the heat generators 19, 20 reach the acceptable power Win.

The process then proceeds to step S27, where the control system 80 instructs the external charger 23 to output the charger power Wchg. Thereafter, in step S28, the control system 80 controls the temperature management system 50 in the battery heating mode. In this way, when any of the heat generators 19 to 21 has become abnormal, the control system 80 stops the abnormal heat generators (step S22), reduces the charger power Wchg (step S25), and continues the battery warm-up using the other two normal heat generators (step S28).

When the control system 80 controls the temperature management system 50 in the battery heating mode in step S28, the process proceeds to step S29, where the control system 80 determines whether the two heat generators are normal. When the control system 80 determines in step S29 that the number of normal heat generators is not “2,” the process proceeds to step S30. That is, when the control system 80 determines that the two heat generators remain normal, the process proceeds to step S30. In step S30, the control system 80 determines whether the battery temperature exceeds the threshold TB.

When the control system 80 determines in step S30 that the battery temperature exceeds the threshold TB, the process proceeds to step S31, where the control system 80 ends the battery warm-up. When the control system 80 determines in step S30 that the battery temperature is lower than or equal to the threshold TB, the process returns to step S23, where the control system 80 continues the battery warm-up while updating the acceptable power Win and the charger power Wchg.

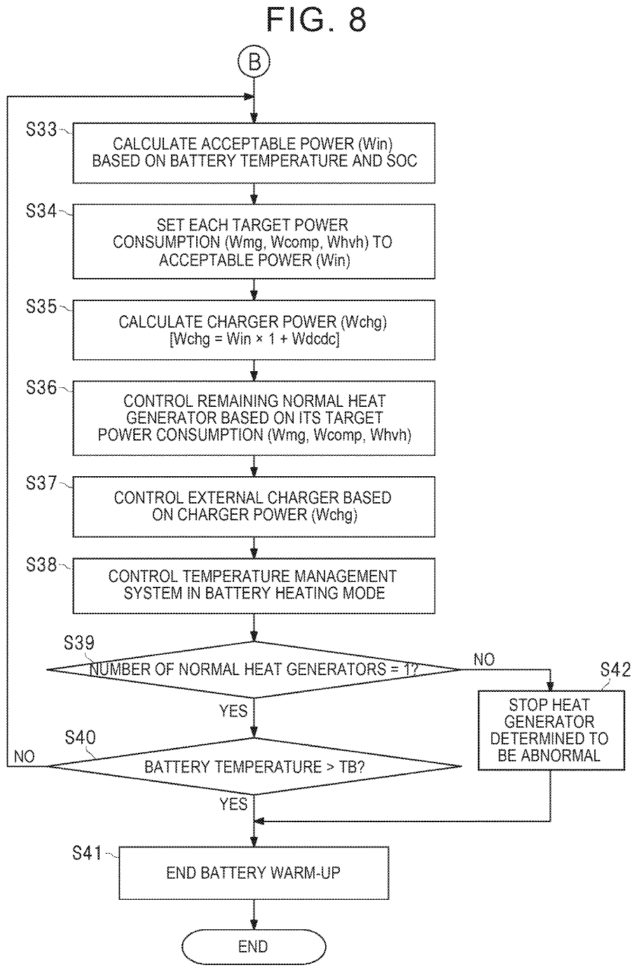

When the control system 80 determines in step S29 that the number of normal heat generators is not “2,” the process proceeds to step S32. That is, when the control system 80 determines that either of the two normal heat generators has become abnormal, the process proceeds to step S32. In step S32, the control system 80 stops the heat generator determined to be abnormal. Thereafter, as illustrated in FIG. 8, the process proceeds to step S33, where the control system 80 calculates the acceptable power Win of the battery pack 15 based on the battery temperature and the SOC.

After the control system 80 calculates the acceptable power Win in step S33, the process proceeds to step S34. In step S34, the control system 80 sets the target power consumption Wmg of the electric axle 19 to the acceptable power Win. In step S34, the control system 80 also sets the target power consumption Wcomp of the electric compressor 20 to the acceptable power Win. In step S34, the control system 80 also sets the target power consumption Whvh of the high-voltage heater 21 to the acceptable power Win. Thereafter, the process proceeds to step S35, where the control system 80 calculates the charger power Wchg requested of the external charger 23, based on the following equation (3).

$$Wchg = Win \times 1 + Wdcdc \qquad ( 3 )$$

The process then proceeds to step S36, where the control system 80 controls the remaining normal heat generator based on its corresponding target power consumption among Wmg, Wcomp, Whvh. For example, when the electric axle 19 is normal among the heat generators 19 to 21, the control system 80 controls the electric axle 19 based on the target power consumption Wmg. In other words, the control system 80 controls the heat generation state of the heat generator 19 such that the power consumption of the heat generator 19 reaches the acceptable power Win.

The process then proceeds to step S37, where the control system 80 instructs the external charger 23 to output the charger power Wchg. Thereafter, in step S38, the control system 80 controls the temperature management system 50 in the battery heating mode. In this way, when either of the two normal heat generators has become abnormal, the control system 80 stops the abnormal heat generator (step S32), reduces the charger power Wchg (step S35), and continues the battery warm-up using the remaining normal heat generator (step S38).

When the control system 80 controls the temperature management system 50 in the battery heating mode in step S38, the process proceeds to step S39, where the control system 80 determines whether the remaining heat generator is normal. When the control system 80 determines in step S39 that the number of normal heat generators is not “1,” the process proceeds to step S40. That is, when the control system 80 determines that the remaining heat generator remains normal, the process proceeds to step S40. In step S40, the control system 80 determines whether the battery temperature exceeds the threshold TB.

When the control system 80 determines in step S40 that the battery temperature exceeds the threshold TB, the process proceeds to step S41, where the control system 80 ends the battery warm-up. When the control system 80 determines in step S40 that the battery temperature is lower than or equal to the threshold TB, the process returns to step S33, where the control system 80 continues the battery warm-up while updating the acceptable power Win and the charger power Wchg. When the control system 80 determines in step S39 that the number of normal heat generators is not “1,” that is, when it determines that the remaining heat generator is abnormal, the process proceeds to step S41, where the control system 80 ends the battery warm-up.

### Abnormal Stop of Heat Generator

As described above in steps S14, S24, S34, the control system 80 sets the target power consumption Wmg of the electric axle 19 to the acceptable power Win, the target power consumption Wcomp of the electric compressor 20 to the acceptable power Win, and the target power consumption Whvh of the high-voltage heater 21 to the acceptable power Win. Accordingly, even when any of the electric axle 19, the electric compressor 20, and the high-voltage heater 21 undergoes an abnormal stop, the surplus power that can no longer be consumed due to such an abnormal stop can be taken into the battery pack 15. Since the respective power consumptions Wmg, Wcomp, Whvh of the heat generators 19 to 21 are each set to the acceptable power Win of the battery pack 15, the surplus power can be properly taken into the battery pack 15 in case of such an abnormal stop.

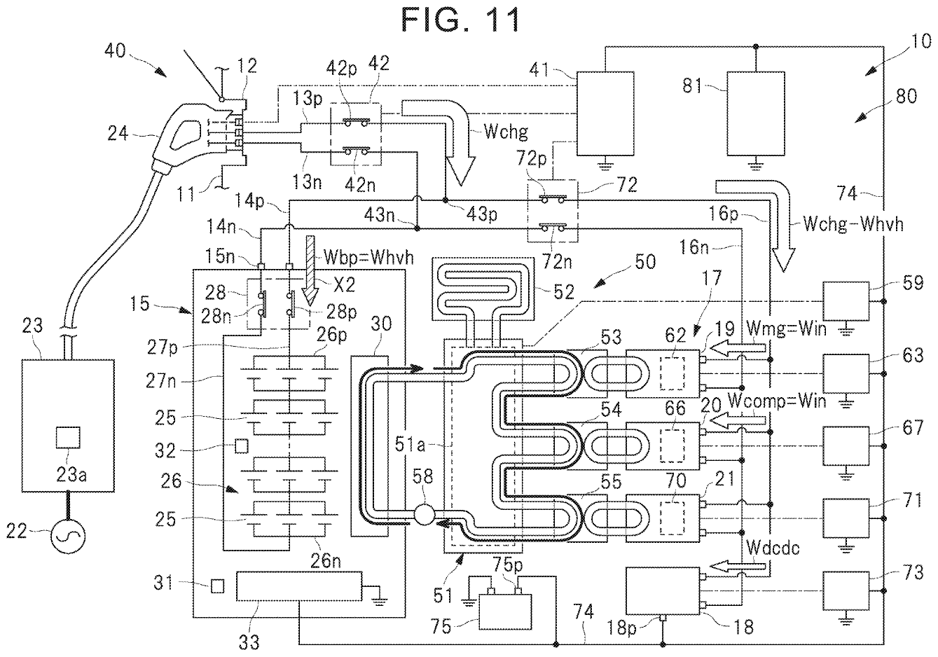

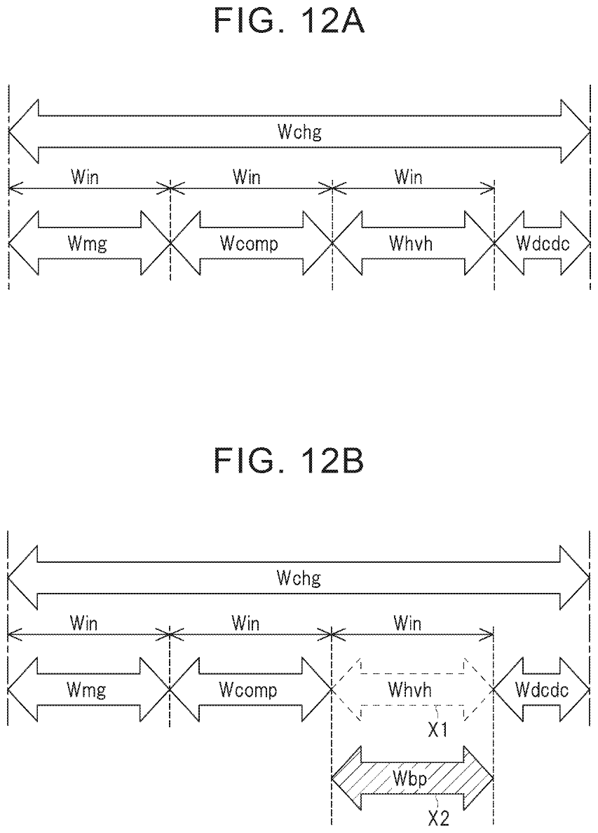

FIG. 11 illustrates an example of the coolant circulation state and the power supply state during warm-up control. FIG. 11 illustrates the state immediately after an abnormal stop of the high-voltage heater 21 from the state illustrated in FIG. 10. FIG. 12A illustrates a breakdown of the consumption of the charger power Wchg illustrated in FIG. 10. FIG. 12B illustrates a breakdown of the consumption of the charger power Wchg illustrated in FIG. 11.

As illustrated in FIGS. 10 and 12A, when all of the heat generators 19 to 21 are normal, the charger power Wchg is consumed by the target power consumption Wmg of the electric axle 19, the target power consumption Wcomp of the electric compressor 20, the target power consumption Whvh of the high-voltage heater 21, and the power consumption Wdcdc of the step-down converter 18. Each of the target power consumptions Wmg, Wcomp, and Whvh is set to the acceptable power Win. The output power Wdcdc of the step-down converter 18 corresponds to the power consumption of the step-down converter 18, and corresponds to the power consumption of the control system 80.

As illustrated in FIG. 11, for example, the target power consumption Whvh of the high-voltage heater 21 disappears immediately after an abnormal stop of the high-voltage heater 21. As a result, the charger power Wchg becomes excessive by an amount corresponding to the target power consumption Whvh. That is, as indicated by reference sign X1 in FIG. 12B, the target power consumption Whvh of the high-voltage heater 21 disappears immediately after an abnormal stop of the high-voltage heater 21. However, since the target power consumption Whvh of the high-voltage heater 21 is set to the acceptable power Win of the battery pack 15. Accordingly, as indicated by reference sign X2 in FIGS. 11 and 12B, the surplus power Wbp can still be appropriately taken into the battery pack 15 even when an abnormal stop of the high-voltage heater 21 occurs.

As described above, even when any of the heat generators 19 to 21 undergoes an abnormal stop, the surplus power can be appropriately taken into the battery pack 15. Accordingly, the target power consumptions Wmg, Wcomp, Whvh of the heat generators 19 to 21 can be increased while protecting the battery pack 15 from excessive charging that would otherwise result from an abnormal stop of any of the heat generators 19 to 21. As a result, the battery pack 15 can be quickly warmed, and the warm-up time can be shortened. Accordingly, the transition to external charging of the battery pack 15 can be made earlier, and the time until completion of charging of the battery pack 15 can be shortened.

In the foregoing description, the electrified vehicle 10 is described as having three heat generators 19 to 21. However, the number of heat generators is not limited to three. For example, the electrified vehicle 10 may include two heat generators, or may include four or more heat generators. In the foregoing description, the electric axle 19 is described as an example of the first heat generator, and the electric compressor 20 is described as an example of the second heat generator. However, the present disclosure is not limited to this. For example, the electric compressor 20 or the high-voltage heater 21 may be used as the first heat generator, and the electric axle 19 or the high-voltage heater 21 may be used as the second heat generator.

### First Modification

In the foregoing description, the target power consumption Wmg of the electric axle 19 is set to the acceptable power Win, the target power consumption Wcomp of the electric compressor 20 is set to the acceptable power Win, and the target power consumption Whvh of the high-voltage heater 21 is set to the acceptable power Win. However, the present disclosure is not limited to this. That is, depending on the magnitude of the power that can be consumed by the heat generators 19 to 21 mounted on the electrified vehicle 10, the target power consumptions Wmg, Wcomp, Whvh of the heat generators 19 to 21 may be set to values lower than or equal to the acceptable power Win.

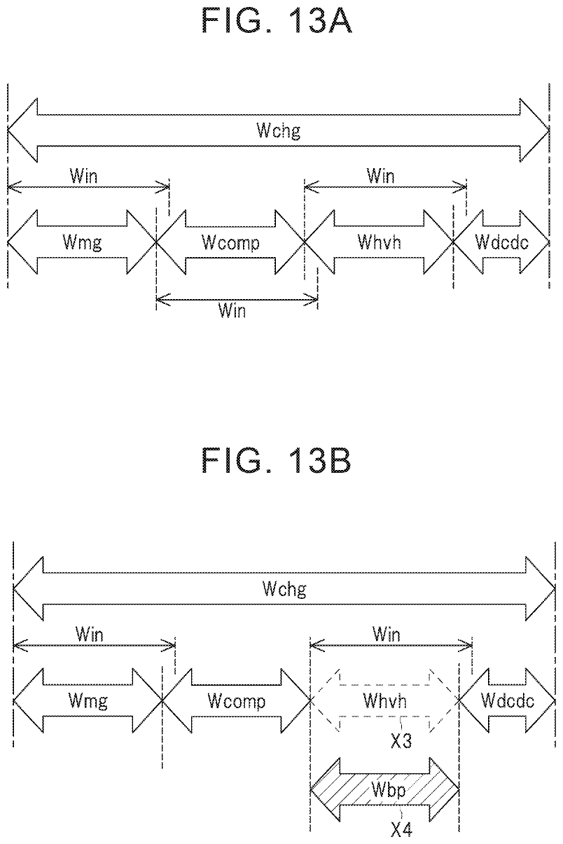

FIGS. 13A and 13B illustrate a breakdown of the consumption of the charger power Wchg during warm-up control according to a modification. As illustrated in FIG. 13A, when the heat generators 19 to 21 are normal, the charger power Wchg is consumed by the target power consumption Wmg of the electric axle 19, the target power consumption Wcomp of the electric compressor 20, the target power consumption Whvh of the high-voltage heater 21, and the power consumption Wdcdc of the step-down converter 18. In this case, each of the target power consumptions Wmg, Wcomp, Whvh is set to a value smaller than the acceptable power Win.

As illustrated in FIG. 13B, for example, the target power consumption Whvh of the high-voltage heater 21 disappears immediately after an abnormal stop of the high-voltage heater 21. As a result, the charger power Wchg becomes excessive by an amount corresponding to the target power consumption Whvh. That is, as indicated by reference sign X3, the target power consumption Whvh of the high-voltage heater 21 disappears immediately after an abnormal stop of the high-voltage heater 21. However, the target power consumption Whvh of the high-voltage heater 21 is set to a value smaller than the acceptable power Win of the battery pack 15. Accordingly, as indicated by reference sign X4, the surplus power Wbp can still be appropriately taken into the battery pack 15 even when an abnormal stop of the high-voltage heater 21 occurs.

In this way, when the control system 80 executes warm-up control, it may control the electric axle 19 based on a target power consumption Wmg smaller than the acceptable power Win, control the electric compressor 20 based on a target power consumption Wcomp smaller than the acceptable power Win, and control the high-voltage heater 21 based on a target power consumption Whvh smaller than the acceptable power Win. That is, when the control system 80 executes warm-up control, it may control the electric axle 19 based on a target power consumption Wmg equal to or lower than the acceptable power Win, control the electric compressor 20 based on a target power consumption Wcomp equal to or lower than the acceptable power Win, and control the high-voltage heater 21 based on a target power consumption Whvh equal to or lower than the acceptable power Win. In other words, the acceptable power Win is used as an upper limit for the target power consumptions Wmg, Wcomp, Whvh.

### Second Modification

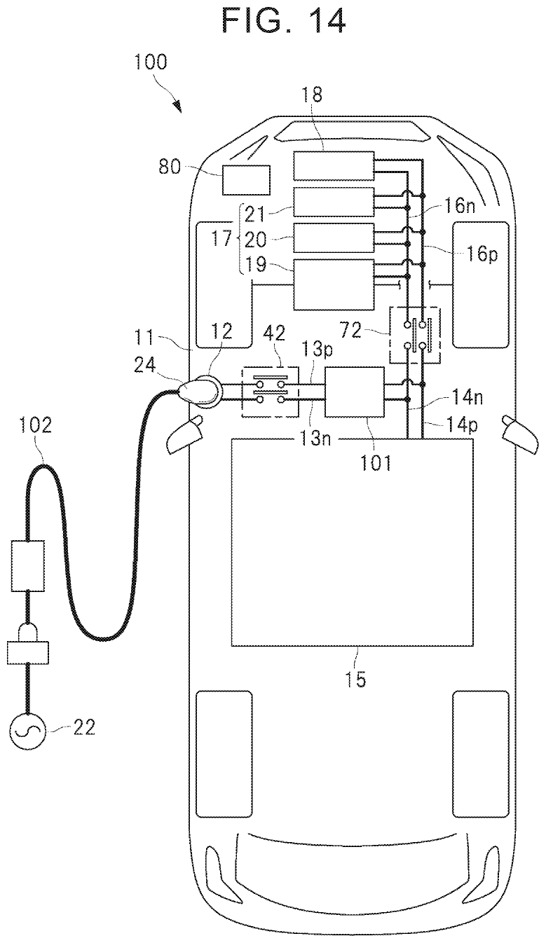

In the example illustrated in FIG. 1, external charging is performed using the external charger 23 installed outside the vehicle. However, the present disclosure is not limited to this. The embodiment of the present disclosure may alternatively be configured to perform external charging using an onboard charger 101 mounted in the vehicle. FIG. 14 illustrates an electrified vehicle 100 according to another modification.

As illustrated in FIG. 14, the electrified vehicle 100 includes the charging inlet 12 provided on the vehicle body 11 and the power lines 13p, 13n coupled to the charging inlet 12. The electrified vehicle 100 further includes the power lines 14p, 14n coupled respectively to the power lines 13p, 13n, and the battery pack 15 coupled to the power lines 14p, 14n. The electrified vehicle 100 further includes an onboard charger (charger) 101 that is a power conversion device provided on the power lines 13p, 13n. That is, the charging inlet 12 is coupled to the battery pack 15 through the power lines 13p, 13n, 14p, 14n and the onboard charger 101.

A charging cable 102 including the charging connector 24 is coupled to the external power source 22 that is a commercial power source. When the charging connector 24 is coupled to the charging inlet 12, the onboard charger 101 converts the alternating current power from the external power source 22 into direct current power, and supplies the direct-current power to the battery pack 15. In this manner, the onboard charger 101 supplies direct current power to the battery pack 15, and the battery pack 15 is charged toward a target SOC.

Thus, even when external charging is performed using the onboard charger 101, the control system 80 controls the electric axle 19 based on a target power consumption Wmg equal to or lower than the acceptable power Win, controls the electric compressor 20 based on a target power consumption Wcomp equal to or lower than the acceptable power Win, and controls the high-voltage heater 21 based on a target power consumption Whvh equal to or lower than the acceptable power Win when executing warm-up control.

With this configuration, even when any of the heat generators undergoes an abnormal stop, the surplus power can be appropriately taken into the battery pack 15. Accordingly, the target power consumptions Wmg, Wcomp, Whvh of the heat generators 19 to 21 can be increased while protecting the battery pack 15 from excessive charging that would otherwise result from an abnormal stop of any of the heat generators 19 to 21. In addition, since the battery pack 15 can be quickly warmed and the warm-up time can be shortened, the transition to external charging of the battery pack 15 can be made earlier, and the time until completion of charging of the battery pack 15 can be shortened.

### Other Modifications

The present disclosure is not limited to the above embodiment, and various modifications may be made without departing from the spirit and scope of the disclosure. In the foregoing description, the acceptable power Win is calculated based on both the battery temperature and the SOC. However, the present disclosure is not limited to this. For example, in an embodiment of the present disclosure, the acceptable power Win may be calculated based on the battery temperature, or may be calculated based on the SOC. In an embodiment of the present disclosure, the target power consumptions Wmg, Wcomp, Whvh may be set based on a preset acceptable power Win without calculating the acceptable power Win based on the battery temperature and/or the SOC.

In the foregoing description, the charger power Wchg includes the output power Wdcdc of the step-down converter 18. However, the present disclosure is not limited to this. In an embodiment of the present disclosure, the output power Wdcdc may be subtracted from the charger power Wchg. Even in the case where the output power Wdcdc is subtracted from the charger power Wchg, the control system 80 can be operated using power from the low-voltage battery 75.

In the foregoing description, the control system 80 is configured by multiple controllers 33, 41, 59, 63, 67, 71, 73, 81. However, the present disclosure is not limited to this. In an embodiment of the present disclosure, the control system 80 may be configured by a single electronic control unit. In the foregoing description, the battery pack 15 made up of a plurality of battery cells 25 is exemplified as the energy storage pack. However, the present disclosure is not limited to this. A capacitor pack made up of a plurality of capacitor cells may be used.

What is claimed is:

1. An electrified vehicle comprising:
a charging inlet provided on a vehicle body;
a first current path configured to be coupled to the charging inlet;
a second current path configured to be coupled to the first current path;
a third current path configured to be coupled to the first current path;
an energy storage pack configured to be coupled to the second current path;
a first heat generator configured to be coupled to the third current path and to supply heat to the energy storage pack;
a second heat generator configured to be coupled to the third current path and to supply heat to the energy storage pack; and
a control system comprising a processor and a memory that are communicatively coupled to each other, wherein:
the control system is configured to execute warm-up control that operates the first heat generator and the second heat generator when a charging connector extending from an external power source is coupled to the charging inlet and a temperature of the energy storage pack falls below a threshold; and
the control system is configured to, upon executing the warm-up control, calculate an acceptable power of the energy storage pack, control the first heat generator based on a first target power consumption that is equal to or lower than the acceptable power, and control the second heat generator based on a second target power consumption that is equal to or lower than the acceptable power.

2. The electrified vehicle according to claim 1, wherein the control system is configured to calculate the acceptable power based on one or both of a temperature of the energy storage pack and a state of charge of the energy storage pack.

3. The electrified vehicle according to claim 1, further comprising:
an inlet-side switch provided in the first current path; and
a unit-side switch provided in the third current path,
wherein the control system is configured to, upon executing the warm-up control, control the inlet-side switch and the unit-side switch to a conducting state and supply power from the external power source to the first heat generator and the second heat generator.

4. The electrified vehicle according to claim 1, wherein the control system is configured to, upon executing the warm-up control, set a requested output power for a charger coupled to the external power source based on the first target power consumption and the second target power consumption.

5. The electrified vehicle according to claim 1, further comprising a step-down converter coupled to the third current path,
wherein the control system is configured to, upon executing the warm-up control, set a requested output power for a charger coupled to the external power source based on the first target power consumption, the second target power consumption, and an output power of the step-down converter.
